(19) United States
(12) Patent Application Publication
(10) Pub. No.: US 2019/0105689 A1
(43) Pub. Date: Apr. 11, 2019

(54) SUBSTRATE CLEANING METHOD

(71) Applicant: EBARA CORPORATION, Tokyo (JP)

(72) Inventors: Makoto KUBOTA, Tokyo (JP); Taiki ISHITSUKA, Tokyo (JP)

(73) Assignee: EBARA CORPORATION, Tokyo (JP)

(21) Appl. No.: 16/152,428

(22) Filed: Oct. 5, 2018

(30) Foreign Application Priority Data
Oct. 11, 2017 (JP) 2017-197641

(51) Int. Cl. B08B 3/04

(52) U.S. Cl. CPC B08B 3/048

(57) ABSTRACT

Provided is a substrate cleaning method capable of maintaining a substrate and a cleaning tank in a clean condition after cleaning. In this method, a substrate holder holding the substrate is immersed in a rinsing liquid in the cleaning tank. While a flow of a cleaning liquid is formed on the substrate, the substrate holder and an inner surface of the cleaning tank, the rinsing liquid is discharged from the cleaning tank. While the flow of the cleaning liquid is formed on the substrate, the substrate holder and the inner surface of the cleaning tank, the rinsing liquid is supplied into the cleaning tank, and the substrate holder is immersed in the rinsing liquid. The substrate holder is pulled up from the rinsing liquid.

### CROSS-REFERENCE TO RELATED APPLICATION

This application claims the priority benefit of Japan Application No. 2017-197641, filed on Oct. 11, 2017. The entirety of the above-mentioned patent application is hereby incorporated by reference herein and made a part of this specification.

### BACKGROUND

### Technical Field

The disclosure relates to a substrate cleaning method in which, before or after a plating treatment is performed on a substrate such as a wafer or the like, a surface of the substrate held by a substrate holder is cleaned using a rinsing liquid.

### Related Art

Since a plating liquid or decomposition products thereof, or foreign matter infiltrating from the outside, adheres to a substrate after plating, the substrate needs to be cleaned after a film formation process performed by plating. In addition, the foreign matter sometimes also adheres to the substrate before plating or a substrate holder holding the substrate. When the foreign matter adheres to the substrate before plating or the substrate holder, the plating liquid that touches the substrate or the substrate holder is contaminated, and a plating bath is further contaminated via the plating liquid in a chain reaction. Hence, a cleaning process for cleaning the substrate or the substrate holder is performed before and after plating.

In such a cleaning process, generally, a method of cleaning the substrate and the substrate holder simultaneously by immersing the substrate together with the substrate holder in a rinsing liquid such as pure water or the like accumulated in a water rinsing bath is used. More specifically, first of all, by keeping a cleaning tank filled with the rinsing liquid such as pure water or the like and lowering the substrate holder holding the substrate toward the cleaning tank, the substrate and the substrate holder are immersed in the rinsing liquid in the cleaning tank. After that, while the substrate holder remains arranged in the cleaning tank, the rinsing liquid in which the plating liquid or foreign matter is diffused due to cleaning is discharged from the cleaning tank. After the rinsing liquid is discharged, a new rinsing liquid is supplied into the cleaning tank, and the substrate and the substrate holder are cleaned with the new rinsing liquid. The process of discharging the rinsing liquid from the cleaning tank and supplying the new rinsing liquid into the cleaning tank, i.e., the so-called quick dump rinse (QDR) process, is repeated multiple times if necessary. After the cleaning is ended, for the purpose of reducing the amount of rinsing liquid used, the rinsing liquid remaining in the cleaning tank is used for the next substrate cleaning.

### PRIOR-ART DOCUMENTS

### Patent Documents

Patent Document 1: Japanese Laid-open No. 2013-211533

However, the plating liquid or foreign matter adhering to the substrate or the substrate holder sometimes adheres to an inner surface of the cleaning tank via the rinsing liquid. When the next substrate cleaning is performed in the state in which the plating liquid or foreign matter adheres to the inner surface of the cleaning tank, the substrate or the substrate holder to be cleaned next is contaminated via the rinsing liquid. In addition, when the rinsing liquid is discharged, the plating liquid or foreign matter is dried and hardened on a surface of the substrate or the substrate holder and the inner surface of the cleaning tank; as a result, cleaning becomes insufficient.

The disclosure provides a substrate cleaning method capable of maintaining a substrate and a cleaning tank in a clean condition after cleaning.

### SUMMARY

According to an embodiment of the disclosure, a substrate cleaning method includes the following steps. A substrate holder holding a substrate is immersed in a rinsing liquid in a cleaning tank. While a flow of a cleaning liquid is formed on the substrate, the substrate holder and an inner surface of the cleaning tank, the rinsing liquid is discharged from the cleaning tank. While the flow of the cleaning liquid is formed on the substrate, the substrate holder and the inner surface of the cleaning tank, the rinsing liquid is supplied into the cleaning tank, and the substrate holder is immersed in the rinsing liquid. The substrate holder is pulled up from the rinsing liquid.

According to an embodiment of the disclosure, while the rinsing liquid is supplied into the cleaning tank and the rinsing liquid is caused to overflow from the cleaning tank, the substrate holder is immersed in the rinsing liquid in the cleaning tank.

According to an embodiment of the disclosure, the cleaning liquid is supplied onto the inner surface of the cleaning tank above an overflow port of the cleaning tank, and the flow of the cleaning liquid is formed on the inner surface of the cleaning tank.

According to an embodiment of the disclosure, by supplying the cleaning liquid to an outer groove provided on an upper portion of a wall of the cleaning tank and causing the cleaning liquid to overflow from the outer groove, the flow of the cleaning liquid is formed on the inner surface of the cleaning tank.

According to an embodiment of the disclosure, the cleaning liquid supplied onto the inner surface of the cleaning tank includes a first cleaning liquid and a second cleaning liquid, and the cleaning liquid supplied onto the inner surface of the cleaning tank is switched from the first cleaning liquid to the second cleaning liquid.

According to an embodiment of the disclosure, when a position of a liquid level of the rinsing liquid in the cleaning tank is higher than a lower end of the substrate holder, a flow of the first cleaning liquid is formed on the inner surface of the cleaning tank. When the position of the liquid level of the rinsing liquid in the cleaning tank is lower than the lower end of the substrate holder, a flow of the second cleaning liquid is formed on the inner surface of the cleaning tank.

According to an embodiment of the disclosure, while the flow of the cleaning liquid is formed on the substrate and the substrate holder, the substrate holder is pulled up from the rinsing liquid.

### BRIEF DESCRIPTION OF THE DRAWINGS

FIG. 1 illustrates an overall arrangement of a plating apparatus equipped with a substrate cleaning apparatus for carrying out one embodiment of a substrate cleaning method of the disclosure.

FIG. 2 is a perspective view showing an outline of a substrate holder shown in FIG. 1.

FIG. 3 is a plan view showing the outline of the substrate holder shown in FIG. 1.

FIG. 4 is a right side view showing the outline of the substrate holder shown in FIG. 1.

FIG. 5 is an enlarged view of portion A in FIG. 4.

FIG. 6 is a schematic view showing the substrate cleaning apparatus capable of carrying out one embodiment of the substrate cleaning method of the disclosure.

FIG. 7 is a top view schematically showing the substrate cleaning apparatus.

FIG. 8A and FIG. 8B are schematic views showing the substrate cleaning method using the substrate cleaning apparatus shown in FIG. 6 in order of processes.

FIG. 9A and FIG. 9B are schematic views showing the substrate cleaning method using the substrate cleaning apparatus shown in FIG. 6 in order of processes.

FIG. 10 is a schematic view showing another embodiment of the substrate cleaning apparatus.

FIG. 11A and FIG. 11B are schematic views showing the substrate cleaning method using the substrate cleaning apparatus shown in FIG. 10 in order of processes.

FIG. 12A and FIG. 12B are schematic views showing the substrate cleaning method using the substrate cleaning apparatus shown in FIG. 10 in order of processes.

FIG. 13A and FIG. 13B are schematic views showing the substrate cleaning method using the substrate cleaning apparatus shown in FIG. 10 in order of processes.

FIG. 14 is a schematic view showing still another embodiment of the substrate cleaning apparatus.

FIG. 15 is a schematic view showing the substrate cleaning method using the substrate cleaning apparatus shown in FIG. 14.

FIG. 16 is an enlarged view showing an overflow port in FIG. 14.

FIG. 17 is a schematic view showing another embodiment of the substrate cleaning apparatus shown in FIG. 14.

FIG. 18 is a schematic view showing still another embodiment of the substrate cleaning apparatus.

FIG. 19 is a schematic view showing a shower nozzle in FIG. 18.

FIG. 20 is a schematic view showing an embodiment of the substrate cleaning apparatus in which a plurality of nozzles are fixed to an inner surface of a cleaning tank.

### DESCRIPTION OF THE EMBODIMENTS

According to the substrate cleaning method of the disclosure, while the rinsing liquid is being discharged from the cleaning tank and while the rinsing liquid is being supplied into the cleaning tank, since the cleaning liquid constantly flows through a surface of the substrate, the substrate holder and the inner surface of the cleaning tank, the cleaning liquid can wash away the rinsing liquid containing a plating liquid or foreign matter that adheres to the surface of the substrate or the substrate holder and the inner surface of the cleaning tank. Accordingly, even after a plurality of substrates are repeatedly cleaned in the cleaning tank, the inner surface of the cleaning tank can be maintained clean. As a result, the substrate and the substrate holder to be cleaned next can be prevented from being contaminated. In addition, according to the substrate cleaning method of the disclosure, it can be prevented that the plating liquid or foreign matter is fixed to the inner surface of the cleaning tank due to evaporation of the rinsing liquid. As a result, the substrate after cleaning can be maintained clean.

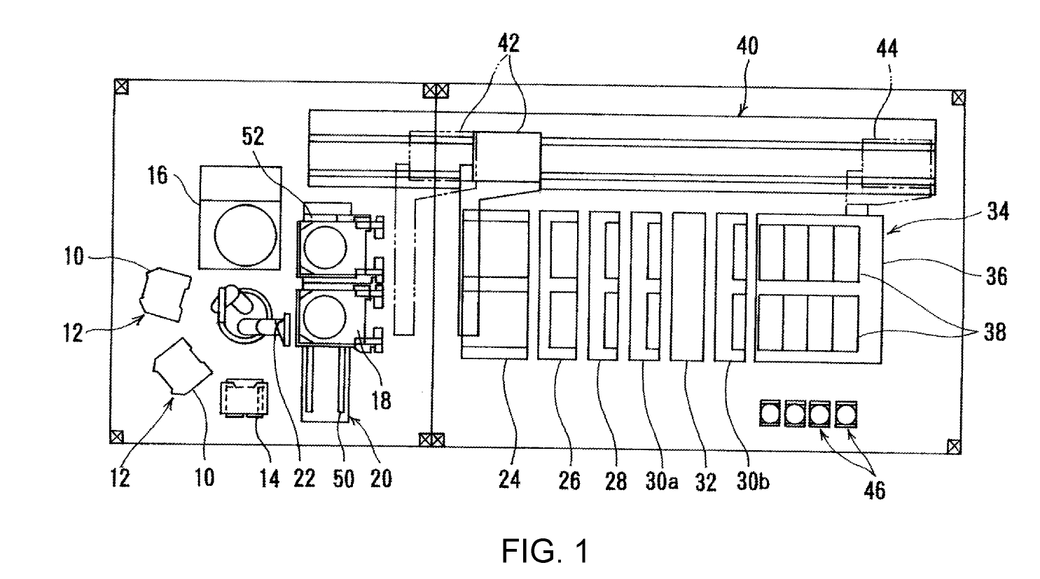

Hereinafter, embodiments of the disclosure are explained with reference to the drawings. FIG. 1 illustrates an overall arrangement of a plating apparatus equipped with a substrate cleaning apparatus for carrying out one embodiment of a substrate cleaning method of the disclosure. As shown in FIG. 1, the plating apparatus includes: two cassette tables 12 each mounted with a cassette 10 storing therein a substrate such as a wafer or the like; an aligner 14 aligning a position of a cutout such as an orientation flat or a notch of a substrate with a predetermined direction; and a spin-rinse dryer 16 rotating a substrate that has undergone a plating treatment at high speed to dry the substrate. A substrate attachment/detachment section 20 is provided near the spin-rinse dryer 16, carrying a substrate holder 18 and attaching and detaching the substrate to and from the substrate holder 18. In the center of a unit including the above elements, a substrate conveyance apparatus 22 composed of a robot for conveyance that conveys the substrate between these elements is arranged.

Furthermore, a stocker 24 storing and temporarily storing therein the substrate holder 18, a pre-wet bath 26 performing a hydrophilic treatment on a surface of the substrate, a pretreatment bath 28 removing, by etching, an oxide film from a surface of a conductive film such as a seed layer or the like formed on the surface of the substrate, a water rinsing bath 30a cleaning the pretreated substrate, a blow bath 32 draining the cleaned substrate, a substrate cleaning apparatus 30b for carrying out one embodiment of a substrate cleaning method of the disclosure that cleans the plated substrate, and a plating bath 34, are arranged in sequence. The plating bath 34 is configured by storing a plurality of plating cells 38 inside an overflow tank 36, wherein each plating cell 38 stores one substrate therein, so as to perform copper plating or metal plating (Sn plating, Au plating, Ag plating, Ni plating, Ru plating, In plating, etc.), and alloy plating (Sn/Ag alloy plating, Sn/In plating, etc.).

Furthermore, the plating apparatus includes a substrate holder conveyance apparatus 40 employing, for example, a linear motor system, the substrate holder conveyance apparatus 40 conveying the substrate holder 18 together with the substrate. The substrate holder conveyance apparatus 40 includes a first transporter 42 conveying the substrate between the substrate attachment/detachment section 20, the stocker 24 and the pre-wet bath 26, and a second transporter 44 conveying the substrate between the stocker 24, the pre-wet bath 26, the pretreatment bath 28, the water rinsing bath 30a, the substrate cleaning apparatus 30b, the blow bath 32 and the plating bath 34. The substrate holder conveyance apparatus 40 may include only the first transporter 42 without including the second transporter 44. In this case, the first transporter 42 is configured capable of conveying the substrate between the substrate attachment/detachment section 20, the stocker 24, the pre-wet bath 26, the pretreatment bath 28, the water rinsing bath 30a, the substrate cleaning apparatus 30b, the blow bath 32 and the plating bath 34.

A paddle driving apparatus 46 is arranged adjacent to the overflow tank 36 of the plating bath 34, driving a paddle (not illustrated) as a stirring rod that is located inside each plating cell 38 and stirs a plating liquid.

The substrate attachment/detachment section 20 includes a carrying plate 52 transversely slidable along a rail 50. On the carrying plate 52, two substrate holders 18 are placed in parallel in a horizontal state. After delivery of the substrate between one of the substrate holders 18 and the substrate conveyance apparatus 22 is performed, the carrying plate 52 is slid transversely, so that delivery of the substrate between the other substrate holder 18 and the substrate conveyance apparatus 22 is performed.

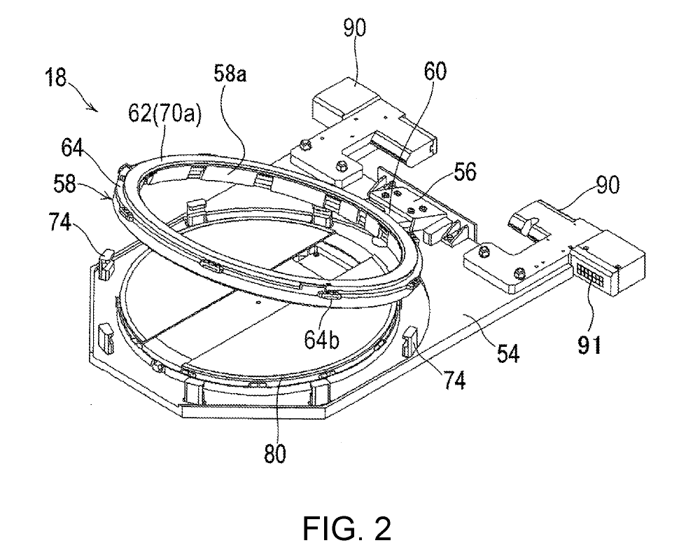

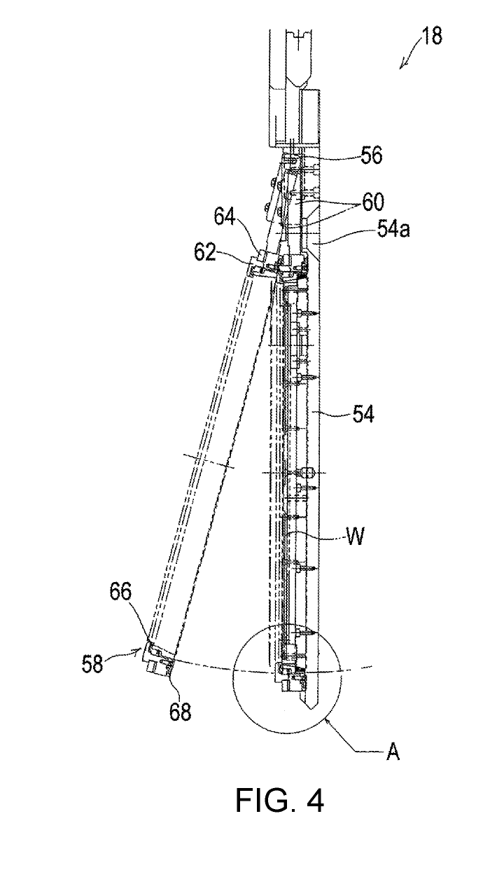

As shown in FIG. 2 to FIG. 5, the substrate holder 18 includes a rectangular plate-like first holding member (base holding member) 54 made of, for example, vinyl chloride, and a second holding member (movable holding member) 58 attached to the first holding member 54 via a hinge 56 in an openable and closable manner. Moreover, although this example shows an example where the second holding member 58 is configured to be openable and closable via the hinge 56, the second holding member 58, for example, may be arranged in a position facing the first holding member 54 so as to open and close by advancing toward the first holding member 54.

The second holding member 58 includes a base 60 and a seal holder 62. The seal holder 62 is made of, for example, vinyl chloride, such that its sliding property with respect to a pressing ring 64 mentioned below is improved. A substrate-side seal projection (first seal projection) 66 is attached to an upper surface of the seal holder 62 to protrude inward, pressing against an outer peripheral portion of a surface of a substrate W and sealing a gap between the substrate W and the second holding member 58 when the substrate W is held by the substrate holder 18. Furthermore, a holder-side seal projection (second seal projection) 68 is attached to a surface of the seal holder 62 facing the first holding member 54, pressing against the first holding member 54 and sealing a gap between the first holding member 54 and the second holding member 58 when the substrate W is held by the substrate holder 18. The holder-side seal projection 68 is located outside the substrate-side seal projection 66.

The substrate-side seal projection (first seal projection) 66 and the holder-side seal projection (second seal projection) 68 are endless seal members. The substrate-side seal projection 66 and the holder-side seal projection 68 may also be seal members such as O-rings or the like. In one embodiment, the second holding member 58 including the substrate-side seal projection 66 and the holder-side seal projection 68 may itself be composed of a material having a sealing function. In the present embodiment, the substrate-side seal projection 66 and the holder-side seal projection 68 have an annular shape and are concentrically arranged. The holder-side seal projection 68 may also be omitted.

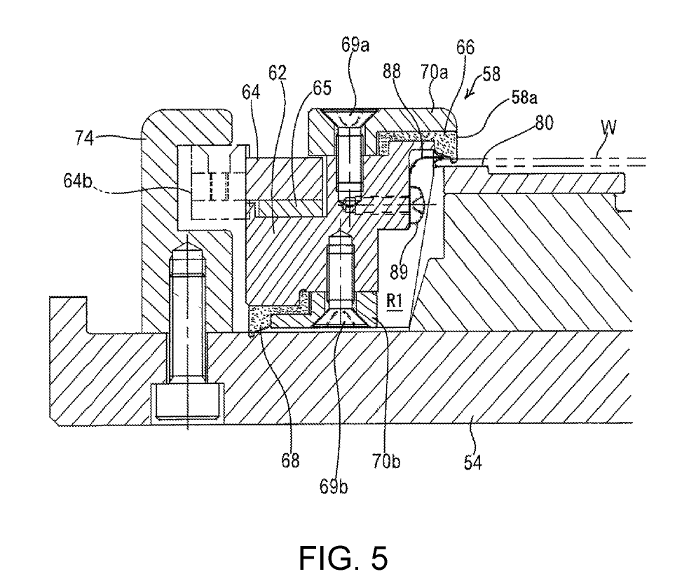

As shown in FIG. 5, the substrate-side seal projection (first seal projection) 66 is sandwiched between the seal holder 62 and a first fixing ring 70a and is attached to the seal holder 62. The first fixing ring 70a is attached to the seal holder 62 via a fastener 69a such as a bolt or the like. The holder-side seal projection (second seal projection) 68 is sandwiched between the seal holder 62 and a second fixing ring 70b and is attached to the seal holder 62. The second fixing ring 70b is attached to the seal holder 62 via a fastener 69b such as a bolt or the like.

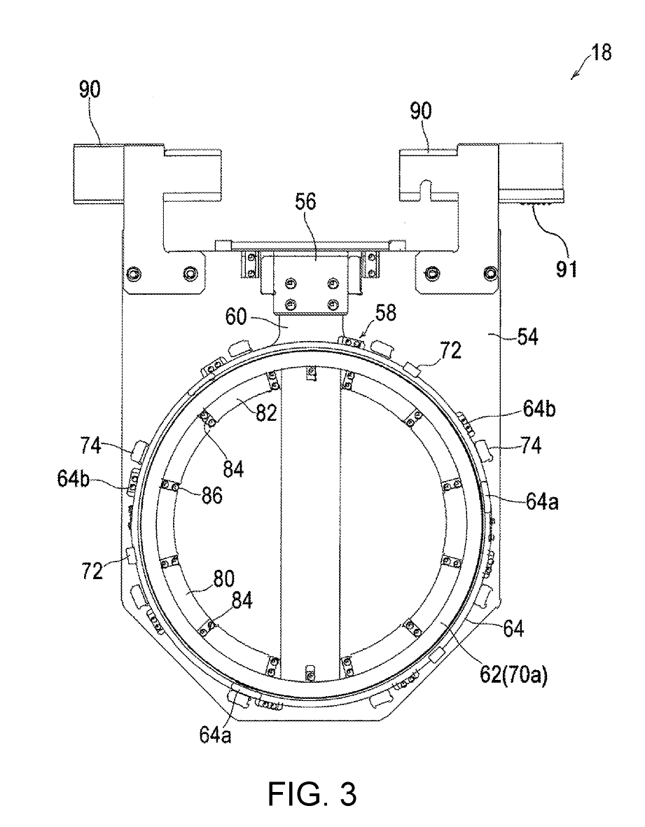

A step portion is provided on an outer peripheral portion of the seal holder 62 of the second holding member 58, and the pressing ring 64 is rotatably mounted on the step portion via a spacer 65. Moreover, due to a pressing plate 72 (see FIG. 3) attached to a side surface of the seal holder 62 so as to protrude outward, the pressing ring 64 is mounted so as to be unable to escape. The pressing ring 64 has excellent corrosion resistance to acids or alkalis, has sufficient rigidity, and is composed of, for example, titanium. The spacer 65 is composed of a material having a low coefficient of friction, for example, polytetrafluoroethylene (PTFE), so that the pressing ring 64 can smoothly rotate.

An inverted L-shaped clamper 74 having an inwardly protruding portion is located outside the pressing ring 64 and erected on the first holding member 54 at equal intervals along a circumferential direction. Meanwhile, an outwardly protruding projecting portion 64b is provided in a position on the pressing ring 64 facing the damper 74 along the circumferential direction. A lower surface of the inwardly protruding portion of the damper 74 and an upper surface of the projecting portion 64b of the pressing ring 64 are formed into tapered surfaces inclined in opposite directions to each other along a rotation direction. A convex portion 64a protruding upward is provided in a plurality of places (for example, three places) on the pressing ring 64 along the circumferential direction. Accordingly, by rotating a rotary pin (not illustrated) to push and rotate the convex portion 64a from the side, the pressing ring 64 can be rotated.

In a state in which the second holding member 58 is open, the substrate W is placed at a central portion of the first holding member 54. Next, by closing the second holding member 58 via the hinge 56 and rotating the pressing ring 64 clockwise to cause the projecting portion 64b of the pressing ring 64 to slide into the inwardly protruding portion of the clamper 74, the first holding member 54 and the second holding member 58 are fastened to each other and locked via the tapered surfaces respectively provided on the pressing ring 64 and the clamper 74. By rotating the pressing ring 64 counterclockwise to remove the projecting portion 64b of the pressing ring 64 from the inverted L-shaped clamper 74, the above lock is released.

In this way, when the second holding member 58 is locked (i.e., when the substrate holder 18 is holding the substrate W), a lower end of a downwardly protruding portion on an inner peripheral surface side of the substrate-side seal projection 66 is uniformly pressed against the outer peripheral portion of the surface of the substrate W, and the gap between the second holding member 58 and the outer peripheral portion of the surface of the substrate W is sealed by the substrate-side seal projection 66. Similarly, a lower end of a downwardly protruding portion on an outer peripheral side of the holder-side seal projection 68 is uniformly pressed against a surface of the first holding member 54, and the gap between the first holding member 54 and the second holding member 58 is sealed by the holder-side seal projection 68.

The substrate holder 18 holds the substrate W by sandwiching the substrate W between the first holding member 54 and the second holding member 58. The second holding member 58 has a circular opening 58a. The opening 58a is slightly smaller than the substrate W in size. When the substrate W is being sandwiched between the first holding member 54 and the second holding member 58, a to-be-treated surface of the substrate W is exposed through the opening 58a. Accordingly, various treatment liquids such as later-described pre-wet liquid, pretreatment liquid, plating liquid and so on can contact an exposed surface of the substrate W held by the substrate holder 18. The exposed surface of the substrate W is surrounded by the substrate-side seal projection (first seal projection) 66.

When the substrate W is held by the substrate holder 18, as shown in FIG. 5, an internal space R1 whose inner peripheral side and outer peripheral side are respectively sealed by the substrate-side seal projection 66 and the holder-side seal projection 68 is formed inside the substrate holder 18. At the central portion of the first holding member 54, a protruding portion 82 protruding in a ring shape in accordance with the size of the substrate W and having a support surface 80 that abuts against the outer peripheral portion of the substrate W and supports the substrate W is provided. A concave portion 84 is provided in a predetermined position on the protruding portion 82 along the circumferential direction.

As shown in FIG. 3, a plurality of (twelve in the drawing) conductors (electric contacts) 86 are respectively arranged in the concave portions 84, and the conductors 86 are respectively connected to a plurality of wirings extending from an external contact 91 provided on a hand 90. When the substrate W is placed on the support surface 80 of the first holding member 54, an end portion of the conductor 86 is exposed in a state of having spring properties on the surface of the first holding member 54 on a side of the substrate W, so as to contact a lower portion of an electric contact 88 shown in FIG. 5.

The electric contact 88 electrically connected to the conductor 86 is fixed to the seal holder 62 of the second holding member 58 via a fastener 89 such as a bolt or the like. The electric contact 88 has a plate spring shape. The electric contact 88 is located outside the substrate-side seal projection 66 and has a contact portion protruding inward in a plate spring shape. The electric contact 88 has spring properties at the contact portion due to elastic force and is easily bent at the contact portion. When the substrate W is held by the first holding member 54 and the second holding member 58, the contact portion of the electric contact 88 is configured to elastically contact an outer peripheral surface of the substrate W supported on the support surface 80 of the first holding member 54.

Opening and closing of the second holding member 58 are performed by an air cylinder (not illustrated) and a dead weight of the second holding member 58. That is, a through hole 54a is provided on the first holding member 54, and the air cylinder is provided in a position facing the through hole 54a when the substrate holder 18 is placed on the substrate attachment/detachment section 20. Accordingly, by extending a piston rod and pushing the seal holder 62 of the second holding member 58 upward by a pressing rod (not illustrated) through the through hole 54a, the second holding member 58 is opened; by retracting the piston rod, the second holding member 58 is closed due to its dead weight.

A pair of substantially T-shaped hands 90 are provided on end portions of the first holding member 54 of the substrate holder 18, serving as a support portion when the substrate holder 18 is conveyed or suspended. The substrate holder 18 is vertically suspended within the stocker 24 by hanging the hands 90 on an upper surface of a peripheral wall of the stocker 24. The hands 90 of the suspended substrate holder 18 are held by the first transporter 42 or the second transporter 44 of the substrate holder conveyance apparatus 40, so that the substrate holder 18 is conveyed. Moreover, in the pre-wet bath 26, the pretreatment bath 28, the water rinsing bath 30a, the substrate cleaning apparatus 30b, the blow bath 32 and the plating bath 34, the substrate holder 18 is also suspended on peripheral walls of the above via the hands 90.

A series of treatments performed by the plating apparatus configured as above are explained. First of all, by the substrate conveyance apparatus 22, one substrate is removed from the cassette 10 mounted on the cassette table 12 and is placed on the aligner 14. The position of the cutout such as an orientation flat or a notch of the substrate is aligned with the predetermined direction. The substrate aligned by the aligner 14 is conveyed to the substrate attachment/detachment section 20 by the substrate conveyance apparatus 22.

In the substrate attachment/detachment section 20, two substrate holders 18 accommodated in the stocker 24 are simultaneously held by the first transporter 42 of the substrate holder conveyance apparatus 40 and conveyed to the substrate attachment/detachment section 20. Then, the substrate holders 18 are lowered in a horizontal state. Thereby, the two substrate holders 18 are simultaneously placed on the carrying plate 52 of the substrate attachment/detachment section 20. Two air cylinders are operated, and the second holding member 58 of the two substrate holders 18 is kept open.

In this state, the substrate conveyed by the substrate conveyance apparatus 22 is inserted into the substrate holders 18 located on a central side, and the air cylinders are reversely operated to close the second holding member 58. After that, the second holding member 58 is locked by a lock/unlock mechanism (not illustrated) above the substrate attachment/detachment section 20. After the substrate has been mounted to one of the substrate holders 18, the carrying plate 52 is slid transversely and the substrate is mounted to the other substrate holder 18 similarly. After that, the carrying plate 52 is returned to its original position.

The substrate is held by the substrate holders 18 while a to-be-treated surface thereof is exposed from the opening 58a of the substrate holders 18. To prevent the plating liquid from infiltrating into the internal space R1, a gap between an outer peripheral portion of the substrate and the second holding member 58 is sealed (tightly closed) by the substrate-side seal projection 66, and the gap between the first holding member 54 and the second holding member 58 is sealed (tightly closed) by the holder-side seal projection 68. The substrate is electrically conducted to a plurality of electric contacts 88 at a portion thereof not in contact with the plating liquid. Wirings extend from the electric contacts 88 to the external contact 91 on the hands 90. By connecting a power supply to the external contact 91, electricity can be supplied to the conductive film such as the seed layer or the like of the substrate.

The substrate holders 18 holding the substrate are conveyed to the pre-wet bath 26 by the first transporter 42 of the substrate holder conveyance apparatus 40. In the pre-wet bath 26, a pre-wet treatment is performed. The pre-wet treatment is a process in which a surface of the substrate held by the substrate holders 18 contacts the pre-wet liquid and hydrophilicity is imparted to the surface of the substrate. In the present embodiment, pure water is used as the pre-wet liquid. However, other liquids may also be used. For example, a liquid containing the same components as the plating liquid may be used. In the case where the plating liquid is copper sulfate plating liquid, an aqueous solution containing dilute sulfuric acid, metal ions and chlorine ions or a single or a combination of additives such as an accelerator, an inhibitor, a leveler and so on may be used.

Next, the substrate holders 18 holding the substrate are conveyed to the pretreatment bath 28 similarly to the above, and an oxide film on the surface of the substrate is etched in the pretreatment bath 28 to expose a clean metal surface. Furthermore, the substrate holders 18 holding the substrate are conveyed to the water rinsing bath 30a similarly to the above, and the surface of the substrate is cleaned with pure water placed in the water rinsing bath 30a.

The substrate holders 18 holding the cleaned substrate are held by the second transporter 44 of the substrate holder conveyance apparatus 40 and conveyed to the plating bath 34 filled with the plating liquid. The substrate holders 18 are suspended in the plating cells 38. The second transporter 44 of the substrate holder conveyance apparatus 40 sequentially repeats the above operation to sequentially convey the substrate holders 18 mounted with the substrate to the plating cells 38 of the plating bath 34 and suspend the substrate holders 18 in predetermined positions.

After the substrate holders 18 are suspended, a plating voltage is applied between an anode (not illustrated) in the plating cells 38 and the substrate. At the same time, while the paddle immersed in the plating liquid is reciprocally moved in parallel with the surface of the substrate, plating is performed on the surface of the substrate. At this moment, the substrate holders 18 are suspended and fixed on an upper portion of the plating cells 38 by the hands 90, and electricity is supplied from a plating power supply to the conductive film such as the seed layer or the like through the conductors 86 and the electric contacts 88. During apparatus operation, circulation of the plating liquid from the overflow tank 36 to the plating cells 38 is basically constantly performed. The temperature of the plating liquid is substantially maintained fixed by a constant temperature unit (not illustrated) in a circulation line.

After plating is ended, the application of the plating voltage and the reciprocal movement of the paddle are stopped. The substrate holders 18 holding the plated substrate are held by the second transporter 44 of the substrate holder conveyance apparatus 40, and are conveyed to the substrate cleaning apparatus 30b similarly as the above, and the surface of the substrate is cleaned.

Next, the substrate holders 18 holding the cleaned substrate are conveyed to the blow bath 32 similarly to the above. Here, by blowing the air or an N₂ gas, water drops adhering to the substrate holders 18 and the surface of the substrate held by the substrate holders 18 are removed, and the substrate holders 18 and the surface of the substrate held by the substrate holders 18 are dried.

The second transporter 44 of the substrate holder conveyance apparatus 40 repeats the above operation to convey the substrate holders 18 holding the plated substrate to the blow bath 32. The first transporter 42 of the substrate holder conveyance apparatus 40 holds the substrate holders 18 dried in the blow bath 32 and places the substrate holders 18 on the carrying plate 52 of the substrate attachment/detachment section 20.

Then, the second holding member 58 of the substrate holders 18 located on the central side is unlocked via the lock/unlock mechanism, and the air cylinders are operated to open the second holding member 58. At this moment, a spring member (not illustrated) different from the electric contacts 88 is provided on the second holding member 58 of the substrate holders 18. The second holding member 58 is desirably prevented from opening while the substrate is stuck to the second holding member 58. After that, the substrate in the substrate holders 18, which has undergone the plating treatment, is removed by the substrate conveyance apparatus 22, transported to the spin-rinse dryer 16, and cleaned with pure water. Then, the substrate is spin-dried (drained) by high-speed rotation of the spin-rinse dryer 16. Then, the spin-dried substrate is returned to the cassette 10 by the substrate conveyance apparatus 22.

After, or in parallel with, the substrate mounted on one of the substrate holders 18 being returned to the cassette 10, the carrying plate 52 is slid transversely, and the substrate mounted on the other substrate holder 18 is similarly spin-dried and returned to the cassette 10.

By the substrate conveyance apparatus 22, a substrate to be newly treated is mounted on the substrate holder 18 from which the substrate has been removed, and a continuous treatment is performed. In the case where there is no substrate to be newly treated, the substrate holder 18 from which the substrate has been removed is held by the first transporter 42 of the substrate holder conveyance apparatus 40 and is returned to a predetermined place in the stocker 24.

Then, all the substrates are removed from the substrate holder 18, spin-dried and returned to the cassette 10, and the operation is completed. In this way, all the substrates are subjected to the plating treatment, and cleaned and dried by the spin-rinse dryer 16, and the substrate holder 18 is returned to the predetermined place in the stocker 24, and the series of operations are completed.

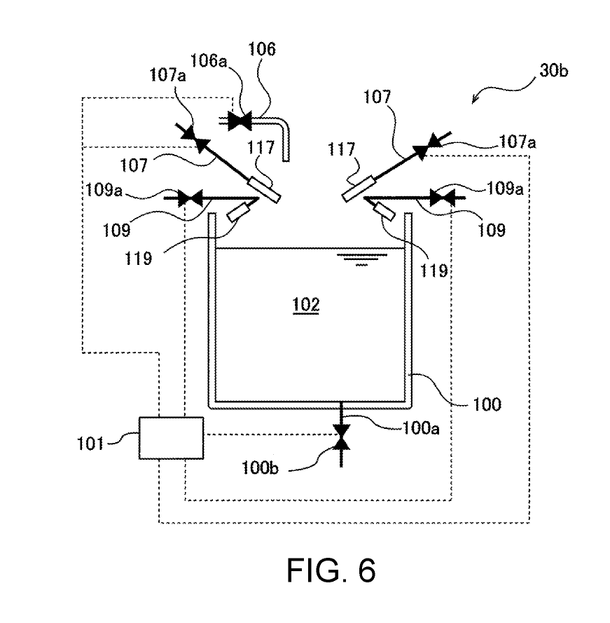

Next, one embodiment of the substrate cleaning method of the disclosure is explained in detail. FIG. 6 is a schematic view showing the substrate cleaning apparatus 30b capable of carrying out one embodiment of the substrate cleaning method of the disclosure. As shown in FIG. 6, the substrate cleaning apparatus 30b includes: a cleaning tank 100 open upward; a rinsing liquid line 106 supplying a rinsing liquid 102 into the cleaning tank 100; a plurality of substrate cleaning nozzles 117 supplying a cleaning liquid onto the substrate holder 18; a plurality of substrate cleaning liquid supply lines 107 supplying the cleaning liquid to the substrate cleaning nozzles 117; a plurality of tank cleaning nozzles 119 supplying the cleaning liquid onto an inner surface of the cleaning tank 100; and a plurality of tank cleaning liquid supply lines 109 supplying the cleaning liquid to the tank cleaning nozzles 119. The substrate cleaning nozzles 117 are respectively connected to the substrate cleaning liquid supply lines 107; the tank cleaning nozzles 119 are respectively connected to the tank cleaning liquid supply lines 109.

A valve 106a is attached to the rinsing liquid line 106. Furthermore, a plurality of valves 107a are respectively attached to the substrate cleaning liquid supply lines 107, and each substrate cleaning liquid supply line 107 is connected to a cleaning liquid source (not illustrated). When the valves 107a are opened, the cleaning liquid is supplied from the cleaning liquid source to each substrate cleaning nozzle 117 through each substrate cleaning liquid supply line 107. When the valves 107a are closed, the supply of the cleaning liquid is stopped. A plurality of valves 109a are respectively attached to the tank cleaning liquid supply lines 109, and each tank cleaning liquid supply line 109 is connected to the cleaning liquid source (not illustrated). When the valves 109a are opened, the cleaning liquid is supplied from the cleaning liquid source to each tank cleaning nozzle 119 through each tank cleaning liquid supply line 109. When the valves 109a are closed, the supply of the cleaning liquid is stopped.

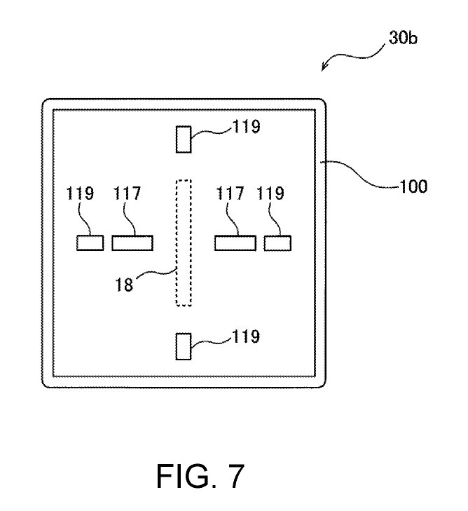

The substrate cleaning nozzles 117 are arranged in positions higher than an upper end of the cleaning tank 100 and face toward the inside of the cleaning tank 100. More specifically, when the substrate holder 18 is arranged in the cleaning tank 10, the substrate cleaning nozzles 117 are arranged in a direction facing the substrate holder 18, and are arranged in positions where they supply the cleaning liquid to an upper portion of the substrate holder 18 from obliquely above. FIG. 7 is a top view schematically showing the substrate cleaning apparatus 30b. In the example shown in FIG. 7, two substrate cleaning nozzles 117 are respectively arranged on a front side and a back side of the substrate holder 18. In one embodiment, four or more substrate cleaning nozzles 117 may be respectively arranged on the front side, the back side, and both side surface sides of the substrate holder 18.

A plurality of tank cleaning nozzles 119 are arranged facing the inner surface of the cleaning tank 100. Liquid outlets of these tank cleaning nozzles 119 are located at the same height as an upper portion of the inner surface of the cleaning tank 100, and are arranged in positions where they supply the cleaning liquid to the upper portion of the inner surface of the cleaning tank 100 from obliquely above. In the present embodiment, the inner surface of the cleaning tank 100 is composed of a front surface, a back surface and two side surfaces, and at least one, in an exemplary embodiment, a plurality of tank cleaning nozzles 119 are arranged on each surface. Although in the example shown in FIG. 7, one tank cleaning nozzle 119 is arranged on each of the front surface, the back surface and the two side surfaces, the disclosure is not limited thereto. For example, two or more tank cleaning nozzles 119 may be provided on each surface.

As shown in FIG. 6, the cleaning tank 100 has on a bottom thereof a drain 100a for discharging the rinsing liquid 102 and the cleaning liquid accumulated in the cleaning tank 100. A drain valve 100b is attached to the drain 100a. When the drain valve 100b is opened, the rinsing liquid 102 and the cleaning liquid are discharged through the drain 100a.

The valves 106a, 107a, 109a and the drain valve 100b are actuator-driven valves including an actuator. Examples of the actuator-driven valve include an electromagnetic valve, an electric valve, an air-operated valve and so on. The valves 106a, 107a, 109a and the drain valve 100b are electrically connected to a valve controller 101 controlling opening and closing of these valves. The valves 106a, 107a, 109a and the drain valve 100b are operated by the valve controller 101.

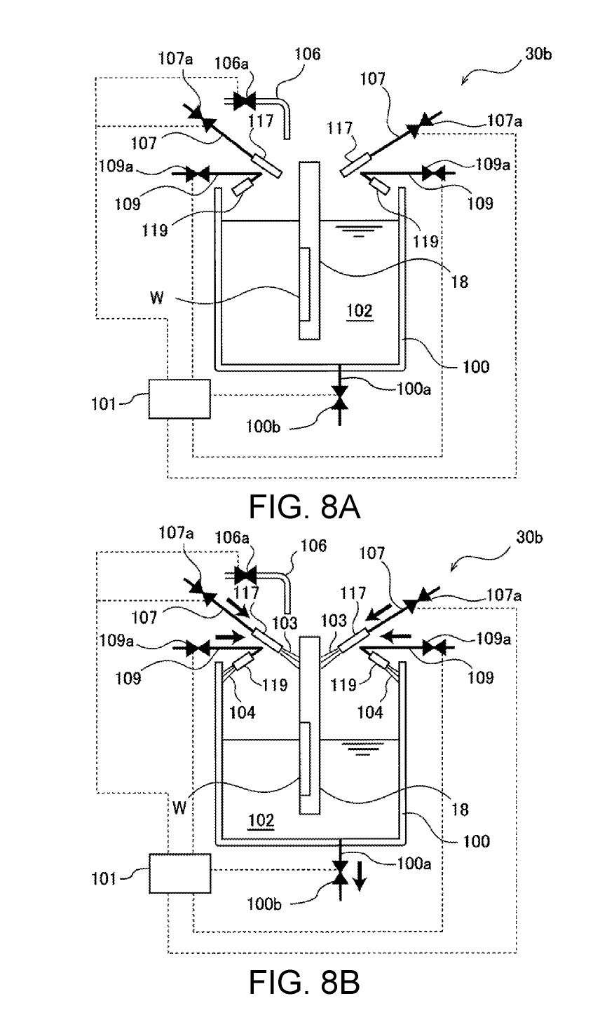

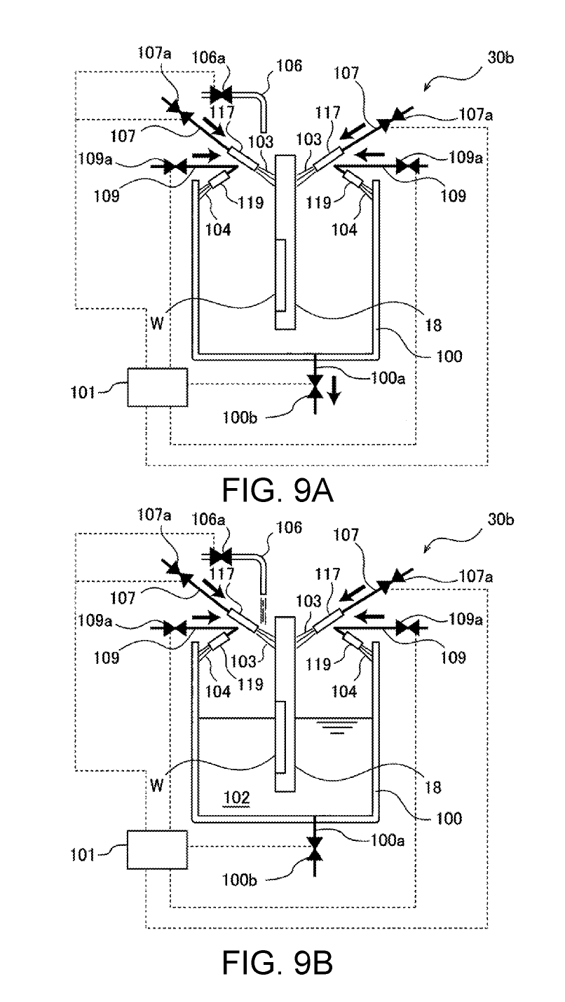

A substrate cleaning method using the substrate cleaning apparatus 30b shown in FIG. 6 is explained in order of processes with reference to FIG. 8A, FIG. 8B, FIG. 9A and FIG. 9B. First of all, as shown in FIG. 8A, the substrate holder 18 holding the substrate W is immersed in the rinsing liquid 102 in the cleaning tank 100. Accordingly, the surface of the substrate W and the substrate holder 18 are cleaned with the rinsing liquid 102 in the cleaning tank 100. The rinsing liquid 102 is supplied from the rinsing liquid line 106 into the cleaning tank 100 in advance and is accumulated in the cleaning tank 100. The cleaning is basically a cleaning to remove the plating liquid or foreign matter adhering to the substrate W or the substrate holder 18 by diffusion by a difference in concentration between liquids. As the time allowed for the substrate holder 18 to be immersed in the rinsing liquid 102 increases, the amount of the plating liquid or foreign matter diffusing from the substrate holder 18 or the substrate W increases and the cleaning effect is improved. In order to improve the cleaning effect in a short time, the rinsing liquid 102 may be stirred by bubbling or by a paddle or the like.

Next, as shown in FIG. 8B, the valve controller 101 opens the drain valve 100b, and the rinsing liquid 102 containing the plating liquid or foreign matter is discharged from the cleaning tank 100. At the same time as the rinsing liquid 102 is discharged, the valve controller 101 opens the valve 107a, a cleaning liquid 103 is supplied from the substrate cleaning nozzle 117 onto the substrate holder 18 and the substrate W, and a flow of the cleaning liquid 103 is formed on the substrate holder 18 and the substrate W. The cleaning liquid 103 flows downward through the front side and back side of the substrate holder 18 and the surface of the substrate W, wetting the substrate holder 18 and the surface of the substrate W. The substrate cleaning nozzle 117 is arranged in a position higher than a position of a liquid level of the rinsing liquid 102 shown in FIG. 8A. Hence, the cleaning liquid 103 supplied from the substrate cleaning nozzle 117 flows through an entire surface of the substrate holder 18 and the substrate W in contact with the rinsing liquid 102. During discharge of the rinsing liquid 102, the cleaning liquid 103 is constantly supplied from the substrate cleaning nozzle 117 onto the substrate holder 18 and the substrate W, and the substrate holder 18 and the substrate W are maintained in the wet state by the cleaning liquid 103. Specific examples of the substrate cleaning nozzle 117 include a spray nozzle, a shower nozzle, a slit nozzle, a multi-hole nozzle, a single-hole nozzle and so on.

Similarly, at the same time as the rinsing liquid 102 is discharged, the valve controller 101 opens the valve 109a, a cleaning liquid 104 is supplied from the tank cleaning nozzle 119 onto the inner surface of the cleaning tank 100, and a flow of the cleaning liquid 104 is formed on the inner surface of the cleaning tank 100. The cleaning liquid 104 flows downward through the inner surface of the cleaning tank 100, wetting the inner surface of the cleaning tank 100. The tank cleaning nozzle 119 is arranged in a position higher than the position of the liquid level of the rinsing liquid 102 shown in FIG. 8A. Hence, the cleaning liquid 104 supplied from the tank cleaning nozzle 119 flows through the entire inner surface of the cleaning tank 100 in contact with the rinsing liquid 102. During discharge of the rinsing liquid 102, the cleaning liquid 104 is constantly supplied from the tank cleaning nozzle 119 onto the inner surface of the cleaning tank 100, and the inner surface of the cleaning tank 100 is maintained in the wet state by the cleaning liquid 104. Specific examples of the tank cleaning nozzle 119 include a spray nozzle, a shower nozzle, a slit nozzle, a multi-hole nozzle, a single-hole nozzle and so on. In the present embodiment, the rinsing liquid 102 as well as the cleaning liquids 103 and 104 are pure water.

Then, as shown in FIG. 9A, all of the rinsing liquid 102 is discharged from the cleaning tank 100, and the cleaning tank 100 becomes empty. At this moment, the cleaning liquids 103 and 104 are still constantly and continuously supplied onto the substrate holder 18, the substrate W and the inner surface of the cleaning tank 100, and the substrate holder 18, the substrate W and the inner surface of the cleaning tank 100 are maintained in the wet state.

As shown in FIG. 9B, after the cleaning tank 100 has become empty, the cleaning liquids 103 and 104 are continuously supplied onto the substrate holder 18, the substrate W and the inner surface of the cleaning tank 100. While flows of the cleaning liquids 103 and 104 are formed on the substrate holder 18, the substrate W and the inner surface of the cleaning tank 100, the valve controller 101 closes the drain valve 100b and opens the valve 106a. While the cleaning liquids 103 and 104 flow through the substrate holder 18, the substrate W and the inner surface of the cleaning tank 100, a new rinsing liquid 102 is supplied into the cleaning tank 100 through the rinsing liquid line 106, and the substrate holder 18 holding the substrate W is immersed in the new rinsing liquid 102 in the cleaning tank 100. After the entire substrate W held by the substrate holder 18 is again immersed in the rinsing liquid 102, the substrate holder 18 is pulled up from the rinsing liquid 102 in the cleaning tank 100 by the substrate holder conveyance apparatus 40, and the cleaning is ended. In order to prevent foreign matter from adhering to the substrate holder 18 and the substrate W, during pull-up of the substrate holder 18 from the rinsing liquid 102 in the cleaning tank 100, the cleaning liquid 103 may be supplied onto the substrate holder 18 and the substrate W to form the flow of the cleaning liquid 103 on the substrate holder 18 and the substrate W. The rinsing liquid 102 remaining in the cleaning tank 100 may be discharged from the drain 100a or may be used for the next substrate cleaning.

In this way, according to the present embodiment, while the rinsing liquid 102 is being discharged from the cleaning tank 100 and while the rinsing liquid 102 is being supplied into the cleaning tank 100, since the cleaning liquids 103 and 104 constantly flow through the surface of the substrate W, the substrate holder 18 and the inner surface of the cleaning tank 100, the cleaning liquids 103 and 104 can wash away the rinsing liquid 102 containing the plating liquid or foreign matter that adheres to the substrate holder 18 and the surface of the substrate W, or the inner surface of the cleaning tank 100. Accordingly, even after a plurality of substrates are repeatedly cleaned in the cleaning tank 100, the inner surface of the cleaning tank 100 can be maintained clean. As a result, the substrate and the substrate holder to be cleaned next can be prevented from being contaminated. In addition, according to the present embodiment, it can be prevented that the plating liquid or foreign matter is fixed to the inner surface of the cleaning tank 100 due to evaporation of the rinsing liquid 102. As a result, the substrate W after cleaning can be maintained clean.

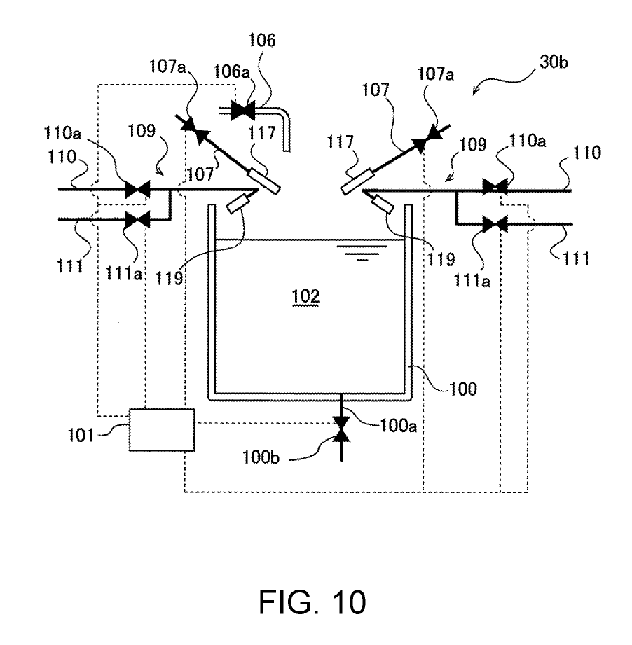

FIG. 10 is a schematic view showing another embodiment of the substrate cleaning apparatus 30b. The configuration of the present embodiment that is not particularly explained is the same as that in the embodiment explained with reference to FIG. 6 and FIG. 7. Thus, repeated explanation is omitted. As shown in FIG. 10, each of a plurality of tank cleaning liquid supply lines 109 of the substrate cleaning apparatus 30b of the present embodiment includes a first cleaning liquid supply line 110 and a second cleaning liquid supply line 111. The first cleaning liquid supply line 110 and the second cleaning liquid supply line 111 communicate with the tank cleaning nozzle 119. A valve 110a is attached to each first cleaning liquid supply line 110, and each first cleaning liquid supply line 110 is connected to a first cleaning liquid source (not illustrated). A valve 111a is attached to each second cleaning liquid supply line 111, and each second cleaning liquid supply line 111 is connected to a second cleaning liquid source (not illustrated). The valves 110a and 111a are electrically connected to the valve controller 101 and are operated by the valve controller 101.

It is configured that different types of cleaning liquids can be respectively supplied from the first cleaning liquid supply line 110 and the second cleaning liquid supply line 111 to the tank cleaning nozzle 119. The valve controller 101 is capable of switching the cleaning liquid supplied to the tank cleaning nozzle 119 by operating the valves 110a and 111a. More specifically, when the valve controller 101 opens the valve 110a and closes the valve 111a, a first cleaning liquid is supplied to the tank cleaning nozzle 119 through the first cleaning liquid supply line 110. When the valve controller 101 closes the valve 110a and opens the valve 111a, a second cleaning liquid is supplied to the tank cleaning nozzle 119 through the second cleaning liquid supply line 111. The first cleaning liquid and the second cleaning liquid supplied to the tank cleaning nozzle 119 can also be switched during cleaning of the substrate W and the substrate holder 18.

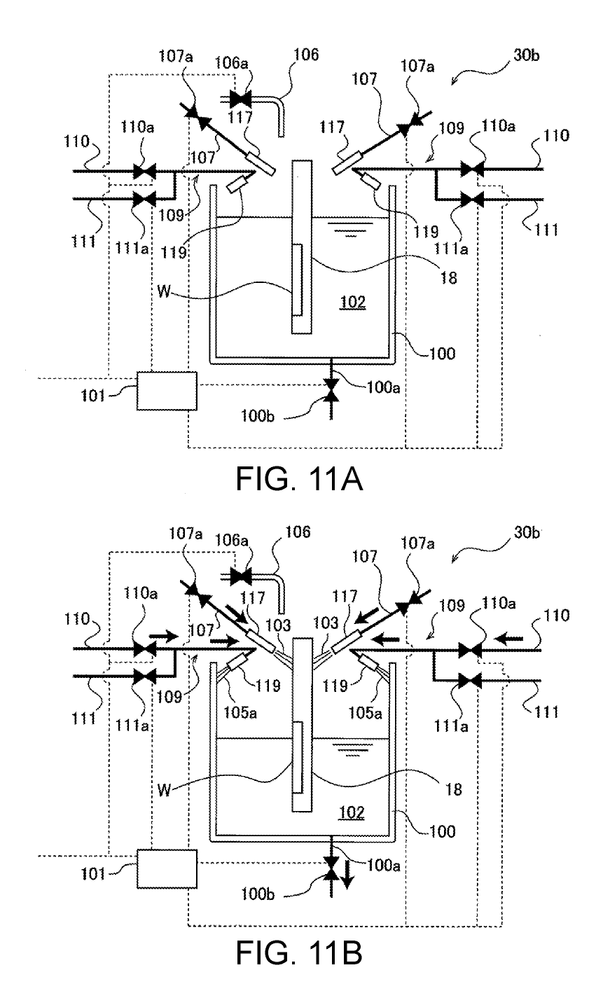

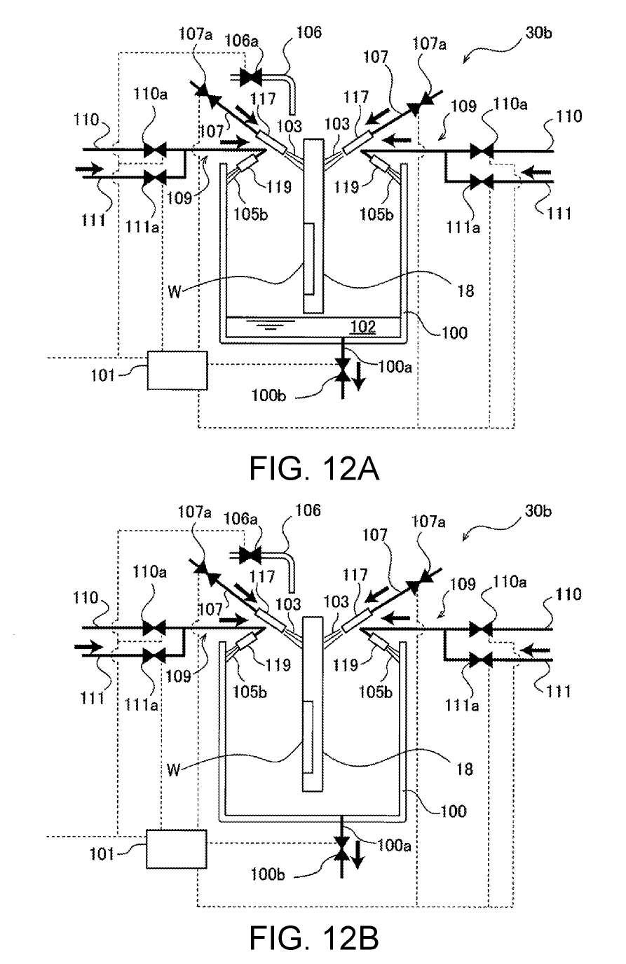

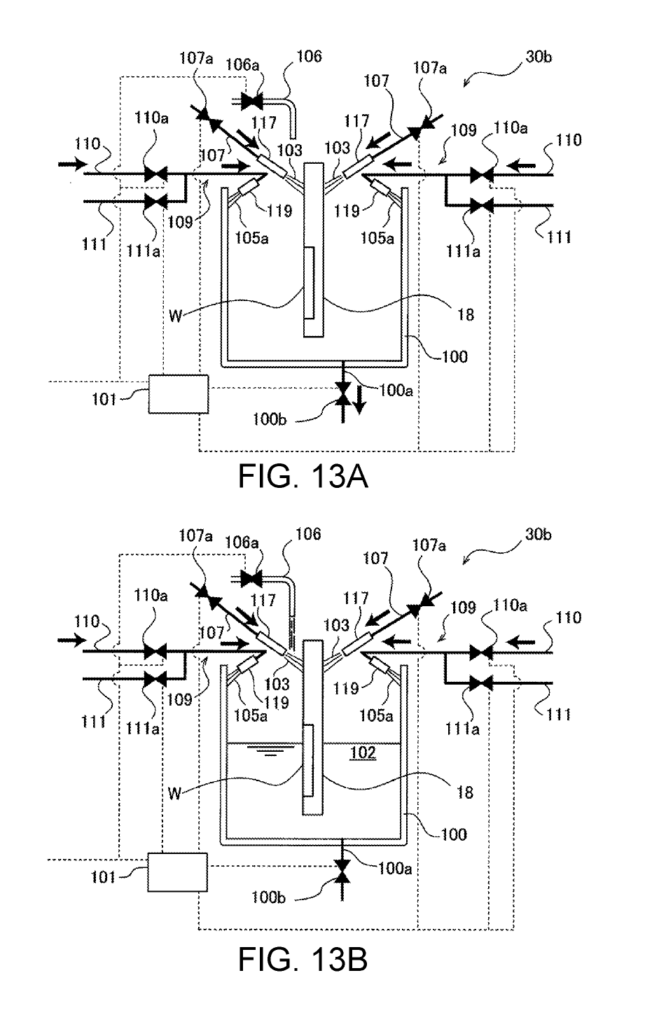

A substrate cleaning method using the substrate cleaning apparatus 30b shown in FIG. 10 is explained in order of processes with reference to FIG. 11A, FIG. 11B, FIG. 12A, FIG. 12B, FIG. 13A and FIG. 13B. First of all, as shown in FIG. 11A, the substrate holder 18 holding the substrate W is immersed in the rinsing liquid 102 in the cleaning tank 100. Accordingly, the surface of the substrate W and the substrate holder 18 are cleaned with the rinsing liquid 102 in the cleaning tank 100. The rinsing liquid 102 is supplied from the rinsing liquid line 106 into the cleaning tank 100 in advance and is accumulated in the cleaning tank 100. The cleaning is basically a cleaning to remove the plating liquid or foreign matter adhering to the substrate W or the substrate holder 18 by diffusion by a difference in concentration between liquids. As the time allowed for the substrate holder 18 to be immersed in the rinsing liquid 102 increases, the amount of the plating liquid or foreign matter diffusing from the substrate holder 18 or the substrate W increases and the cleaning effect is improved. In order to improve the cleaning effect in a short time, the rinsing liquid 102 may be stirred by bubbling or by a paddle or the like.

Next, as shown in FIG. 11B, the valve controller 101 opens the drain valve 100b, and the rinsing liquid 102 containing the plating liquid or foreign matter is discharged from the cleaning tank 100. At the same time as the rinsing liquid 102 is discharged, the valve controller 101 opens the valve 107a, the cleaning liquid 103 is supplied from the substrate cleaning nozzle 117 onto the substrate holder 18 and the substrate W, and the flow of the cleaning liquid 103 is formed on the substrate holder 18 and the substrate W. The cleaning liquid 103 flows downward through the front side and back side of the substrate holder 18 and the surface of the substrate W, wetting the substrate holder 18 and the surface of the substrate W. The substrate cleaning nozzle 117 is arranged in a position higher than the position of the liquid level of the rinsing liquid 102 shown in FIG. 11A. Hence, the cleaning liquid 103 supplied from the substrate cleaning nozzle 117 flows through the entire surface of the substrate holder 18 and the substrate W in contact with the rinsing liquid 102. During discharge of the rinsing liquid 102, the cleaning liquid 103 is constantly supplied from the substrate cleaning nozzle 117 onto the substrate holder 18 and the substrate W, and the substrate holder 18 and the substrate W are maintained in the wet state by the cleaning liquid 103.

Similarly, at the same time as the rinsing liquid 102 is discharged, the valve controller 101 opens the valve 110a, a cleaning liquid (first cleaning liquid) 105a is supplied from the tank cleaning nozzle 119 onto the inner surface of the cleaning tank 100, and a flow of the cleaning liquid 105a is formed on the inner surface of the cleaning tank 100. The cleaning liquid 105a flows downward through the inner surface of the cleaning tank 100, wetting the inner surface of the cleaning tank 100. The tank cleaning nozzle 119 is arranged in a position higher than the position of the liquid level of the rinsing liquid 102 shown in FIG. 11A. Hence, the cleaning liquid 105a supplied from the tank cleaning nozzle 119 flows through the entire inner surface of the cleaning tank 100 in contact with the rinsing liquid 102. During discharge of the rinsing liquid 102, when the position of the liquid level of the rinsing liquid 102 is higher than a lower end of the substrate holder 18, the cleaning liquid 105a is continuously supplied from the tank cleaning nozzle 119 onto the inner surface of the cleaning tank 100, and the inner surface of the cleaning tank 100 is maintained in the wet state by the cleaning liquid 105a. In the present embodiment, the rinsing liquid 102 and the cleaning liquid 105a are pure water.

Then, as shown in FIG. 12A, the discharge of the rinsing liquid 102 progresses, and the position of the liquid level of the rinsing liquid 102 becomes lower than the lower end of the substrate holder 18. At this moment, the valve controller 101 closes the valve 110a and opens the valve 111a, a cleaning liquid (second cleaning liquid) 105b is supplied from the tank cleaning nozzle 119 onto the inner surface of the cleaning tank 100, and a flow of the cleaning liquid 105b is formed on the inner surface of the cleaning tank 100. The cleaning liquid 105b flows downward through the inner surface of the cleaning tank 100, wetting the inner surface of the cleaning tank 100. During the discharge of the rinsing liquid 102 hereafter, the cleaning liquid 105b is continuously supplied from the tank cleaning nozzle 119 onto the inner surface of the cleaning tank 100, and the inner surface of the cleaning tank 100 is maintained in the wet state by the cleaning liquid 105b. The position of the liquid level of the rinsing liquid 102 can be obtained from a relationship between discharge amount of the rinsing liquid 102 and time. In one embodiment, a liquid level detector detecting the position of the liquid level of the rinsing liquid 102 may be provided in the cleaning tank 100. As the above liquid level detector, an ultrasonic sensor or a float switch or the like may be used. Such a liquid level detector is commercially available.

In the present embodiment, ammonia water or a tetramethylammonium hydroxide (TMAH) aqueous solution is used for the cleaning liquid 105b. These cleaning liquids can remove the plating liquid or foreign matter adhering to the cleaning tank 100, but might have adverse effects on a film formed on the substrate W. Hence, to prevent the cleaning liquid 105b from contacting the substrate W or the substrate holder 18, after the position of the liquid level of the rinsing liquid 102 has become lower than the lower end of the substrate holder 18, the valve controller 101 closes the valve 110a and opens the valve 111a, and the cleaning liquid 105b is supplied from the tank cleaning nozzle 119 onto the inner surface of the cleaning tank 100.

Then, as shown in FIG. 12B, all of the rinsing liquid 102 is discharged from the cleaning tank 100, and the cleaning tank 100 becomes empty. In the state in which the cleaning tank 100 is empty, the cleaning liquid 103 is continuously supplied from the substrate cleaning nozzle 117 onto the substrate holder 18 and the substrate W, and the substrate holder 18 and the substrate W are maintained in the wet state. Similarly, the cleaning liquid 105b is continuously supplied from the tank cleaning nozzle 119 onto the inner surface of the cleaning tank 100, and the inner surface of the cleaning tank 100 is maintained in the wet state.

After that, as shown in FIG. 13A, the valve controller 101 closes the valve 111a and opens the valve 110a, the cleaning liquid 105a is supplied from the tank cleaning nozzle 119 onto the inner surface of the cleaning tank 100, and the flow of the cleaning liquid 105a is formed on the inner surface of the cleaning tank 100. The cleaning liquid 105a flows downward through the inner surface of the cleaning tank 100, wetting the inner surface of the cleaning tank 100. Accordingly, the cleaning liquid 105a washes away the cleaning liquid 105b adhering to the inner surface of the cleaning tank 100.

Then, as shown in FIG. 13B, the cleaning liquids 103 and 105a are continuously supplied onto the substrate holder 18, the substrate W and the inner surface of the cleaning tank 100. While flows of the cleaning liquids 103 and 105a are formed on the substrate holder 18, the substrate W and the inner surface of the cleaning tank 100, the valve controller 101 closes the drain valve 100b and opens the valve 106a. While the cleaning liquids 103 and 105a flow through the substrate holder 18, the substrate W and the inner surface of the cleaning tank 100, a new rinsing liquid 102 is supplied into the cleaning tank 100 through the rinsing liquid line 106, and the substrate holder 18 holding the substrate W is immersed in the new rinsing liquid 102 in the cleaning tank 100. After the entire substrate W held by the substrate holder 18 is again immersed in the rinsing liquid 102, the substrate holder 18 is pulled up from the rinsing liquid 102 in the cleaning tank 100 by the substrate holder conveyance apparatus 40, and the cleaning is ended. In order to prevent foreign matter from adhering to the substrate holder 18 and the substrate W, during pull-up of the substrate holder 18 from the rinsing liquid 102 in the cleaning tank 100, the cleaning liquid 103 may be supplied onto the substrate holder 18 and the substrate W to form the flow of the cleaning liquid 103 on the substrate holder 18 and the substrate W. The rinsing liquid 102 remaining in the cleaning tank 100 may be discharged from the drain 100a or may be used for the next substrate cleaning.

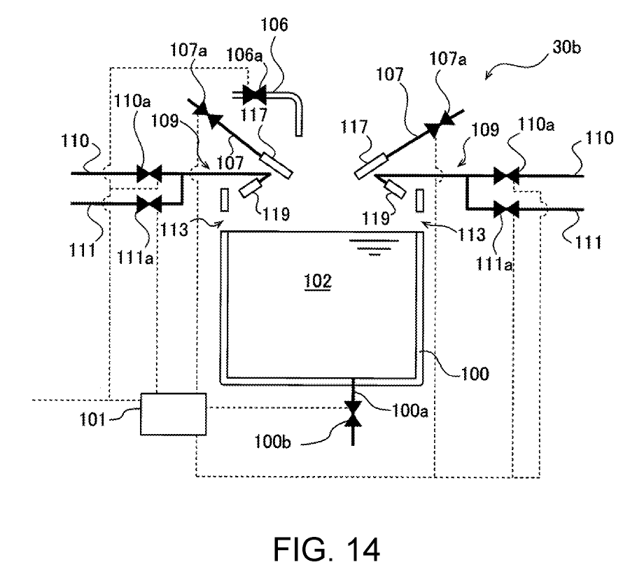

FIG. 14 is a schematic view showing still another embodiment of the substrate cleaning apparatus 30b. The configuration of the present embodiment that is not particularly explained is the same as that in the embodiments explained with reference to FIG. 6, FIG. 7 and FIG. 10. Thus, repeated explanation is omitted. As shown in FIG. 14, the cleaning tank 100 of the substrate cleaning apparatus 30b of the present embodiment has on its sidewall an overflow port 113 allowing the rinsing liquid 102 to overflow therethrough. The overflow port 113 is a through hole passing through the sidewall of the cleaning tank 100, and its size or shape is not limited. In one embodiment, the overflow port 113 may be formed all over the sidewall of the cleaning tank 100. In this case, the sidewall of the cleaning tank 100 above the overflow port 113 and the sidewall of the cleaning tank 100 below the overflow port 113 are separated.

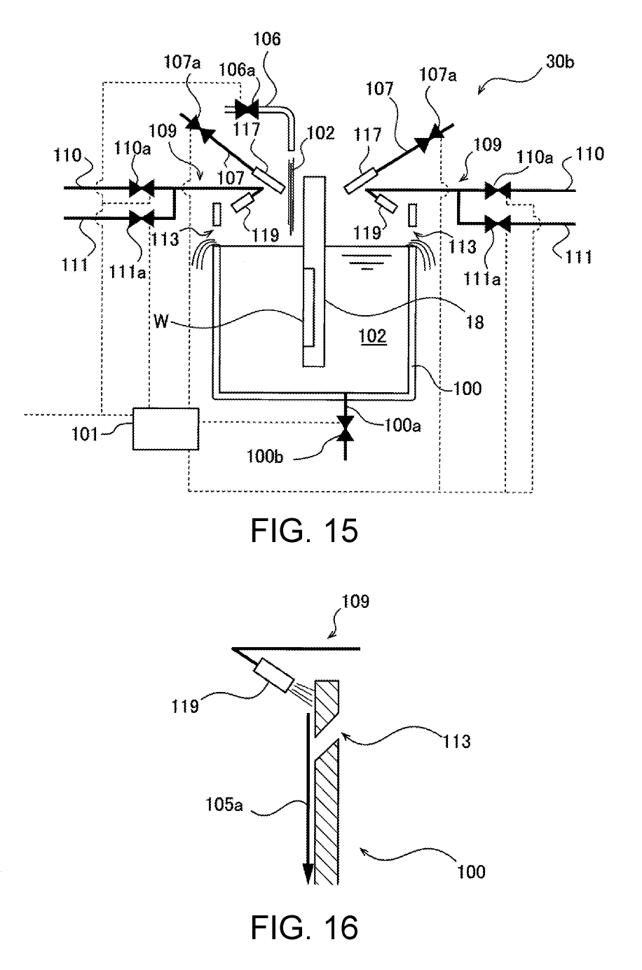

A substrate cleaning method using the substrate cleaning apparatus 30b shown in FIG. 14 is explained in order of processes with reference to FIG. 15. First of all, as shown in FIG. 15, the substrate holder 18 holding the substrate W is immersed in the rinsing liquid 102 in the cleaning tank 100. Accordingly, the surface of the substrate W and the substrate holder 18 are cleaned with the rinsing liquid 102 in the cleaning tank 100. The rinsing liquid 102 is supplied from the rinsing liquid line 106 into the cleaning tank 100 in advance and is accumulated in the cleaning tank 100. The cleaning is basically a cleaning to remove the plating liquid or foreign matter adhering to the substrate W or the substrate holder 18 by diffusion by a difference in concentration between liquids. As the time allowed for the substrate holder 18 to be immersed in the rinsing liquid 102 increases, the amount of the plating liquid or foreign matter diffusing from the substrate holder 18 or the substrate W increases and the cleaning effect is improved. In order to improve the cleaning effect in a short time, the rinsing liquid 102 may be stirred by bubbling or by a paddle or the like.

In the present embodiment, while the substrate W and the substrate holder 18 are being immersed in the rinsing liquid 102 in the cleaning tank 100, the valve controller 101 maintains the valve 106a open, and the rinsing liquid 102 is continuously supplied from the rinsing liquid line 106 into the cleaning tank 100. Accordingly, the rinsing liquid 102 overflows from the cleaning tank 100 through the overflow port 113, and the rinsing liquid 102 in the cleaning tank 100 is replaced with a new rinsing liquid 102 supplied from the rinsing liquid line 106. Accordingly, cleaner rinsing liquid 102 can be used for cleaning.

After that, the valve controller 101 closes the valve 106a to stop the supply of the rinsing liquid 102. Then, the valve controller 101 opens the drain valve 100b, and the rinsing liquid 102 containing the plating liquid or foreign matter is discharged from the cleaning tank 100. The processes hereafter are the same as the processes explained with reference to FIG. 11B, FIG. 12A, FIG. 12B, FIG. 13A and FIG. 13B. Thus, repeated explanation is omitted. Since the rinsing liquid 102 in the cleaning tank 100 overflows through the overflow port 113, the position of the liquid level of the rinsing liquid 102 will not be higher than the overflow port 113. The overflow port 113 can also be used for managing the position of the liquid level of the rinsing liquid 102.

The cleaning liquids 105a and 105b supplied from the tank cleaning nozzle 119 need to contact the entire inner surface of the cleaning tank 100 in contact with the rinsing liquid 102. The position of the liquid level of the rinsing liquid 102 accumulated in the cleaning tank 100 is at the same height as a lower end of the overflow port 113. Hence, the tank cleaning nozzle 119 is located higher than the overflow port 113, and the cleaning liquids 105a and 105b are supplied onto the inner surface of the cleaning tank 100 above the overflow port 113. The cleaning liquids 105a and 105b get over the overflow port 113 to form flows of the cleaning liquids 105a and 105b on the inner surface of the cleaning tank 100, and flow downward through the inner surface of the cleaning tank 100. As a result, the cleaning liquids 105a and 105b can wet the entire inner surface of the cleaning tank 100 in contact with the rinsing liquid 102. In addition, the cleaning liquids 105a and 105b supplied onto the inner surface of the cleaning tank 100 above the overflow port 113 flow down the overflow port 113 and flow through the inner surface of the cleaning tank 100 below the overflow port 113. Accordingly, the lower end of the overflow port 113, in particular, can be effectively cleaned.

FIG. 16 is an enlarged view showing the overflow port 113 in FIG. 14. As shown in FIG. 16, for the purpose of preventing the cleaning liquids 105a and 105b (in the example shown in FIG. 16, the cleaning liquid 105a) supplied onto the inner surface of the cleaning tank 100 from flowing out from the overflow port 113, the overflow port 113 is inclined upward toward the outside of the cleaning tank 100. The embodiment shown in FIG. 14 to FIG. 16 can be combined with the embodiment shown in FIG. 6.

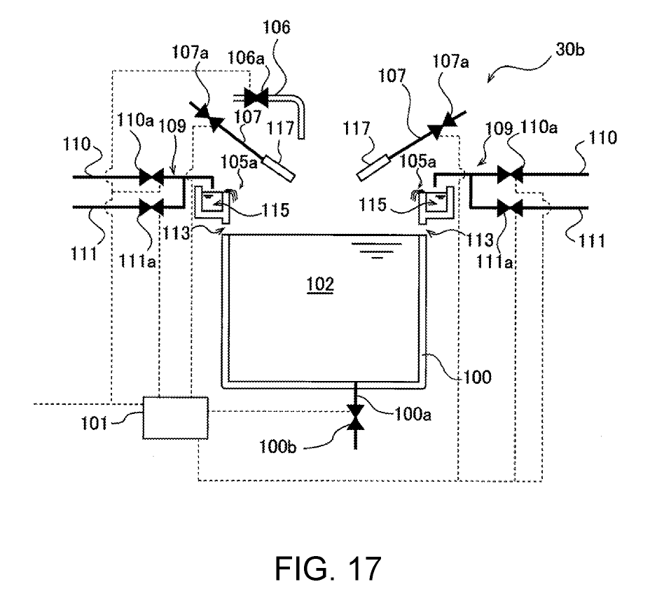

FIG. 17 is a schematic view showing another embodiment of the substrate cleaning apparatus 30b shown in FIG. 14. The configuration of the present embodiment that is not particularly explained is the same as that in the embodiments explained with reference to FIG. 6, FIG. 7, FIG. 10, FIG. 14 and FIG. 16. Thus, repeated explanation is omitted. As shown in FIG. 17, the substrate cleaning apparatus 30b of the present embodiment includes, instead of the tank cleaning nozzle 119, an outer groove 115 on an upper portion of a wall of the cleaning tank 100. The tank cleaning liquid supply line 109 communicates with the outer groove 115, and the cleaning liquids 105a and 105b are supplied into the outer groove 115 through the tank cleaning liquid supply line 109.

The cleaning liquids 105a and 105b (in the example shown in FIG. 17, the cleaning liquid 105a) overflow the outer groove 115, flow downward through the inner surface of the cleaning tank 100 and flow into the cleaning tank 100. In the present embodiment, the flows of the cleaning liquids 105a and 105b are also formed on the inner surface of the cleaning tank 100 and can wet the inner surface of the cleaning tank 100. The embodiment shown in FIG. 17 can be combined with the embodiment shown in FIG. 6 or FIG. 10. The operation of the present embodiment that is not particularly explained is the same as the operation explained with reference to FIG. 15. Thus, repeated explanation is omitted.

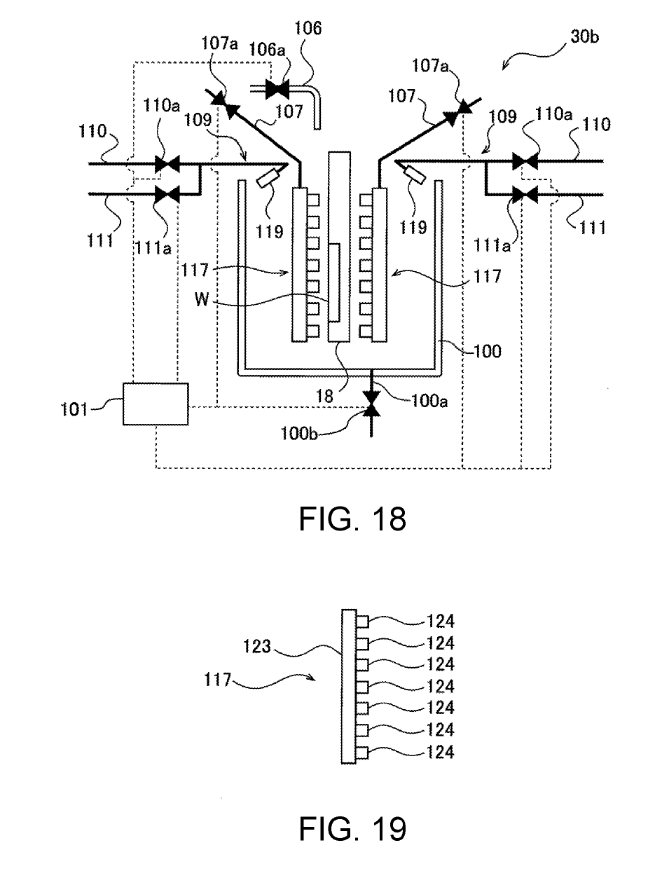

FIG. 18 is a schematic view showing still another embodiment of the substrate cleaning apparatus 30b. The configuration of the present embodiment that is not particularly explained is the same as that in the embodiments explained with reference to FIG. 6, FIG. 7 and FIG. 10. Thus, repeated explanation is omitted. As shown in FIG. 18, the substrate cleaning apparatus 30b of the present embodiment includes a shower nozzle as the substrate cleaning nozzle 117. In the following explanation, the substrate cleaning nozzle 117 is referred to as the shower nozzle 117. As shown in FIG. 19, each shower nozzle 117 includes a nozzle head 123 and a plurality of nozzles 124. The nozzle head 123 is connected to the substrate cleaning liquid supply line 107. The nozzles 124 are fixed to and communicate with the nozzle head 123. The nozzles 124 are arranged along a vertical direction.

In the present embodiment, the cleaning liquid 103 is supplied from the substrate cleaning liquid supply line 107 to the nozzle head 123, and the cleaning liquid 103 is sprayed from the nozzles 124 to the substrate holder 18 and the substrate W. The shower nozzle 117 is arranged in parallel with the front side and back side of the substrate holder 18, and the nozzles 124 are arranged to face the front side and back side of the substrate holder 18. The surface area of the shower nozzle 117 is larger than the surface area of the substrate holder 18 in contact with the rinsing liquid 102. Hence, the cleaning liquid 103 sprayed from the shower nozzle 117 to the substrate holder 18 and the substrate W can wet the entire surface of the substrate holder 18 and the substrate W in contact with the rinsing liquid 102. The operation of the present embodiment that is not particularly explained is the same as the operation explained with reference to FIG. 11A, FIG. 11B, FIG. 12A, FIG. 12B, FIG. 13A and FIG. 13B. Thus, repeated explanation is omitted.

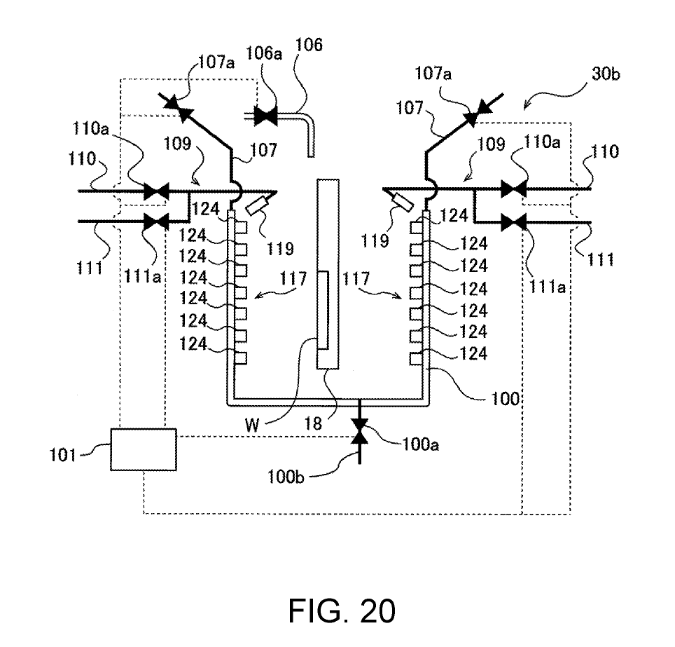

In one embodiment, as shown in FIG. 20, a plurality of nozzles 124 of the shower nozzle 117 may be fixed to the inner surface of the cleaning tank 100. In the present embodiment, the nozzles 124 are connected to the substrate cleaning liquid supply line 107. The nozzles 124 are installed on the inner surface of the cleaning tank 100 facing the front side and back side of the substrate holder 18. The embodiment shown in FIG. 18 or FIG. 20 can be combined with the embodiments explained with reference to FIG. 6, FIG. 14 and FIG. 17. The operation of the present embodiment that is not particularly explained is the same as the operation explained with reference to FIG. 11A, FIG. 11B, FIG. 12A, FIG. 12B, FIG. 13A and FIG. 13B. Thus, repeated explanation is omitted.

The above-mentioned embodiments relate to the substrate cleaning apparatus 30b which cleans a plated substrate. However, the above-mentioned embodiments may also be applied in the water rinsing bath 30a which cleans a substrate before plating. Furthermore, the disclosure may also be applied in a substrate cleaning apparatus of an electroless plating apparatus. Furthermore, the disclosure may also be applied in a cleaning apparatus used in a plating apparatus making a substrate horizontal and performing a plating treatment thereon. Furthermore, in one embodiment, the disclosure may also be applied in a cleaning apparatus used in a batch type plating apparatus simultaneously treating a plurality of substrates.

The above-mentioned embodiments are described in order for persons of ordinary skill in the art to implement the disclosure. Various modifications to the above-mentioned embodiments can, of course, be achieved by those skilled in the art, and the technical idea of the disclosure can also be applied in other embodiments. Accordingly, the disclosure is not limited to the embodiments described herein and is to be interpreted in the broadest scope in accordance with the technical idea defined by the claims.

What is claimed is:

1. A substrate cleaning method, comprising:
immersing a substrate holder holding a substrate in a rinsing liquid in a cleaning tank;
while forming a flow of a cleaning liquid on the substrate, the substrate holder and an inner surface of the cleaning tank, discharging the rinsing liquid from the cleaning tank;
while forming the flow of the cleaning liquid on the substrate, the substrate holder and the inner surface of the cleaning tank, supplying the rinsing liquid into the cleaning tank, and immersing the substrate holder in the rinsing liquid; and
pulling up the substrate holder from the rinsing liquid.

2. The substrate cleaning method according to claim 1, comprising, while supplying the rinsing liquid into the cleaning tank and causing the rinsing liquid to overflow from the cleaning tank, immersing the substrate holder in the rinsing liquid in the cleaning tank.

3. The substrate cleaning method according to claim 2, wherein the cleaning liquid is supplied onto the inner surface of the cleaning tank above an overflow port of the cleaning tank, and the flow of the cleaning liquid is formed on the inner surface of the cleaning tank.

4. The substrate cleaning method according to claim 1, comprising, by supplying the cleaning liquid to an outer groove provided on an upper portion of a wall of the cleaning tank and causing the cleaning liquid to overflow from the outer groove, forming the flow of the cleaning liquid on the inner surface of the cleaning tank.

5. The substrate cleaning method according to claim 1, wherein the cleaning liquid supplied onto the inner surface of the cleaning tank comprises a first cleaning liquid and a second cleaning liquid, and
the cleaning liquid supplied onto the inner surface of the cleaning tank is switched from the first cleaning liquid to the second cleaning liquid.

6. The substrate cleaning method according to claim 5, comprising:
when a position of a liquid level of the rinsing liquid in the cleaning tank is higher than a lower end of the substrate holder, forming a flow of the first cleaning liquid on the inner surface of the cleaning tank; and
when the position of the liquid level of the rinsing liquid in the cleaning tank is lower than the lower end of the substrate holder, forming a flow of the second cleaning liquid on the inner surface of the cleaning tank.

7. The substrate cleaning method according to claim 1, comprising, while forming the flow of the cleaning liquid on the substrate and the substrate holder, pulling up the substrate holder from the rinsing liquid.
